(19) United States
(12) Patent Application Publication
(10) Pub. No.: US 2004/0153268 A1
(43) Pub. Date: Aug. 5, 2004

(54) Spectral evaluation of an object to be tested

(76) Inventor: Thomas Volkel, Bad Steben (DE)

Correspondence Address: SIEMENS CORPORATION, INTELLECTUAL PROPERTY DEPT., 170 WOOD AVENUE SOUTH, ISELIN, NJ, 08830, US

(21) Appl. No.: 10/764,295

(22) Filed: Jan. 23, 2004

(30) Foreign Application Priority Data
Aug. 8, 2001 (DE) 10138919.1
Jul. 31, 2002 (WO) PCT/DE02/02814

(51) Int. Cl. G06F 19/00

(52) U.S. Cl. 702/75; 702/189

(57) ABSTRACT

The invention relates to a method for the spectral evaluation of an object to be tested. The inventive method enables an evaluation to be carried out independently of the respective operating state of the object to be tested, said operating state being influenced by operating parameters. A first operating parameter is an actual rotational speed value. According to the inventive method, a frequency spectrum (22, 23) of the object to be tested is automatically recorded by measuring means. Said frequency spectrum (22, 23) has first amplitude values which depend on first frequency values, the first frequency values of the frequency spectrum (22, 23) being used for normalisation in relation to the actual rotational speed value. An alarm curve (2) is formed with second amplitude values which depend on second frequency values, the second frequency values of the alarm curve (2) being used for normalisation in relation to the actual rotational speed value. The second amplitude values of the alarm curve (2) are changed according to the operating parameter, the first amplitude values of the normalised frequency spectrum (22, 23) are compared with the second amplitude values of the normalised alarm curve (2) which is modified according to the operating parameter, and the result of the comparison is used to evaluate the object to be tested.

The invention relates to a method for the spectral evaluation of an object to be tested.

Such a method is used in the acoustic testing of objects to be tested. An acoustic diagnosis, as it is called, is common particularly in the case of equipment and large machines which have moving and/or rotating sub-components. Equipment and/or machines of this type may, for example, be engines, generators, turbines, blowers and many other things. The method is also used for monitoring vibrations in car gear units. In such a method, vibration or acceleration sensors (e.g. a microphone) are fitted near bearings, drives or shafts. A large amount of technical information can be derived from the acoustic and/or mechanical vibrations and the structure-borne noise, as it is called. In this way it is, for example, possible to detect at an early stage defects in an object to be tested. In addition, forms of known disturbance variables attributable to manufacturing, manifestations of ageing attributable to wear and tear and much more can be observed.

German patent application DE 40 17 448 A1 describes a method for diagnosing the mechanical properties of machines in which rotating components which cause vibrations are present. In order to establish a fast and reliable method by means of which routinely obtained vibration patterns can be processed in order to diagnose typical machine faults, the detection signal is transformed, using a frequency transformation method, from the time range to the frequency range and the signal is analyzed in the frequency range.

From document WO 96/13011 a vibration monitoring system for a machine is known, said system containing a microcontroller and a machine to be monitored. The machine contains at least one rotating element and at least one sensor for converting the machine's mechanical vibrations into a corresponding electrical signal, which is then evaluated by the microcontroller.

U.S. Pat. No. 5,109,700 describes a method and a device for analyzing rotating machines. Here, a vibration sensor connected to the rotating machine records the vibration of the machine and generates a corresponding electrical output signal. The device is provided in order to analyze the electrical signal and to output and/or display the signal level, the rotational speed and the state of the bearings of the machine.

The object of the invention is to indicate a method for the spectral evaluation of an object to be tested, said method enabling an evaluation to be carried out independently of the respective operating state of the object to be tested.

This object is achieved in a method for the spectral evaluation of an object to be tested in operating states characterized by operating parameters, a first operating parameter being an actual rotational speed value, whereby automatically

a frequency spectrum of the object to be tested is recorded by measuring means, said frequency spectrum having first amplitude values which depend on first frequency values,

the first frequency values of the frequency spectrum are used for normalization in relation to the actual rotational speed value,

an alarm curve is formed with second amplitude values which depend on second frequency values,

the second frequency values of the alarm curve are used for normalization in relation to the actual rotational speed value,

the second amplitude values of the alarm curve are changed according to the operating parameters,

the first amplitude values of the normalized frequency spectrum are compared with the second amplitude values of the normalized alarm curve which is changed according to the operating parameters, and a result of the comparison is used to evaluate the object to be tested.

Vibro-acoustic analysis is frequently used for monitoring machines. In this method, the amplitudes of characteristic frequency components of the object to be tested (e.g. bearings, gears, fans, etc.) are evaluated. By this means, an envelope alarm curve over the spectrum is produced. If the amplitude of a frequency component breaches the alarm curve, an alarm is generated. This alarm curve usually has to be specifically defined by the user of a vibro-acoustic testing system during configuration. The evaluation of spectrums can be carried out only under defined, i.e. constant, conditions/operating states of the object to be tested. This becomes a problem if the object to be tested assumes a different operating state from that on which the configuration of the alarm curve is based, i.e. operates with an altered rotational speed or load, for example. Changes in the rotational speed lead to frequency shifts, and this means that frequency components can exceed their range and thus trigger a false alarm. If the load changes at the same rotational speed, the amplitudes of the frequency components may increase/decrease, which may result either in a false alarm being triggered or in a fault not being detected. The method according to the invention offers an elegant solution to this problem. The alarm curve configured for a defined operating state and the recorded frequency spectrum of the object to be tested are modified in the invention such that an evaluation can be carried out independently of the respective actual operating state.

The method can enable in particular an evaluation of the object to be tested to be carried out independently of the actual load and/or temperature of the object to be tested. The second amplitude values of the alarm curve are to this end changed according to any function of the operating parameters which is specified by a user. This function is available, for example, in the form of a table which contains the assignments between a correction factor for the amplitude value of the alarm curve and the respective operating parameter.

The normalized alarm curve which is modified according to the operating parameters will advantageously form an envelope curve over the normalized frequency spectrum of the object to be tested in a fault-free normal state, and an alarm is then generated if at least one amplitude value of the normalized frequency spectrum lies outside the envelope curve.

The invention is described and explained in detail below with reference to the embodiments shown in the drawings, in which

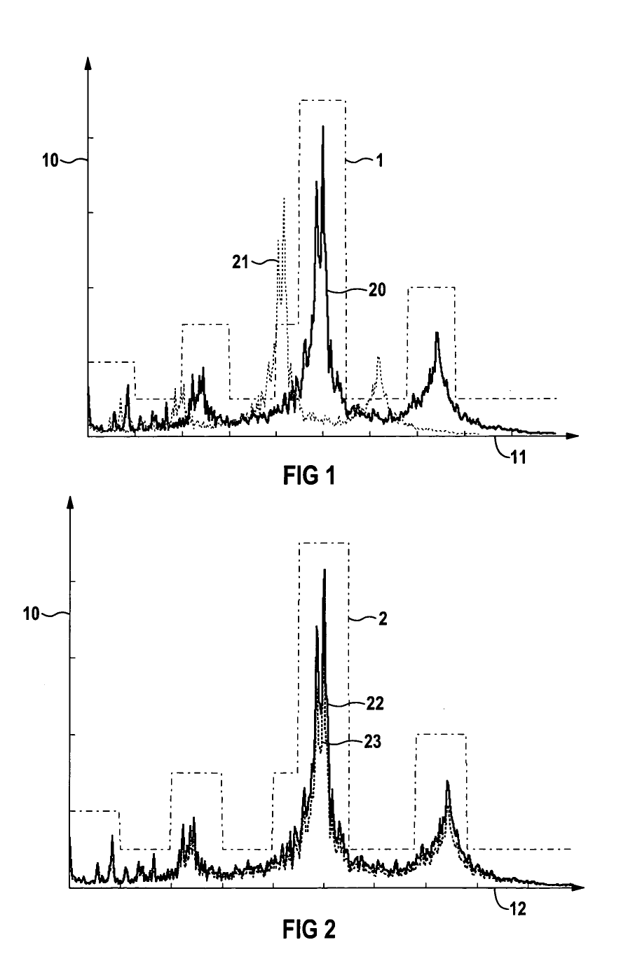

FIG. 1 shows frequency spectrums for various actual rotational speed values and an alarm curve, in each case before processing with the method,

FIG. 2 shows frequency spectrums for various actual rotational speed values and an alarm curve, after implementation of the method,

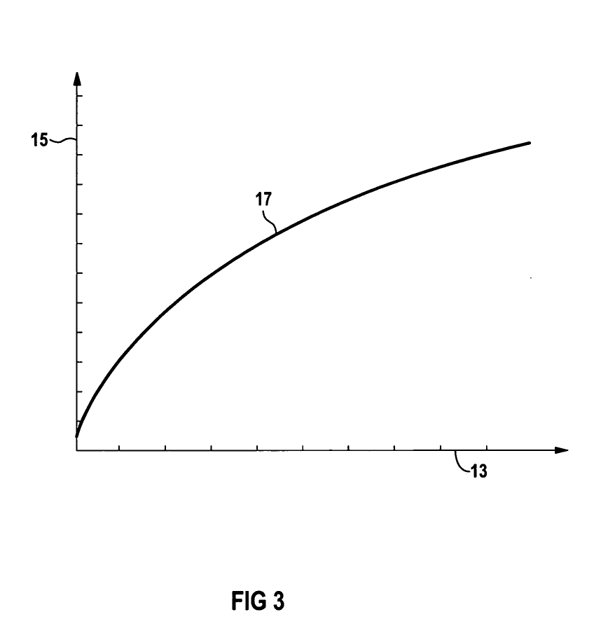

FIG. 3 shows a function between an operating parameter and a correction factor for the amplitude values of the alarm curve,

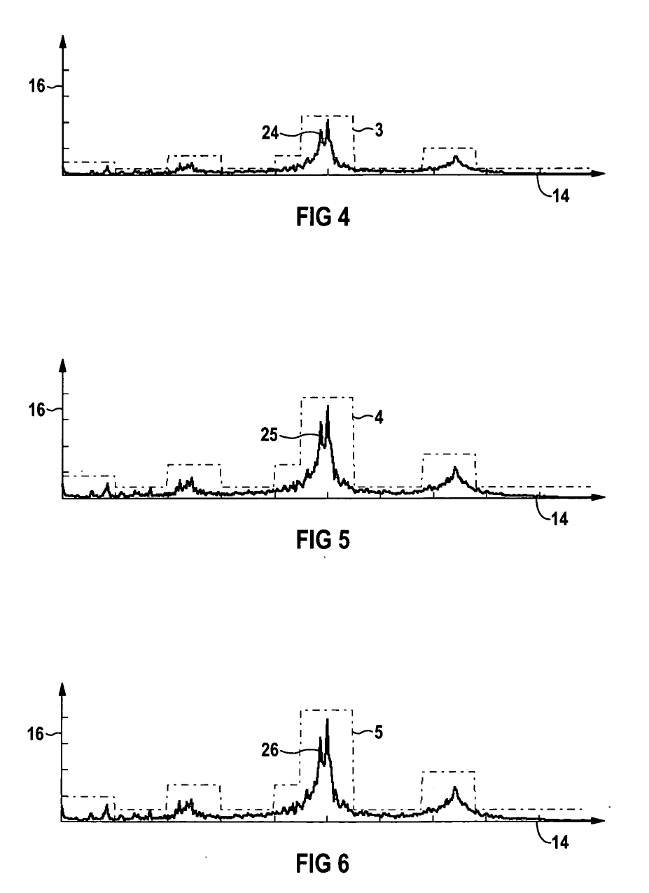

FIG. 4 shows a frequency spectrum and an alarm curve in the no-load operating state,

FIG. 5 shows a frequency spectrum and an alarm curve in the 50%-load operating state,

FIG. 6 shows a frequency spectrum and an alarm curve in the 75%-load operating state.

FIG. 1 shows a diagram with two different frequency spectrums 20, 21 and an alarm curve 1. The amplitude values of the frequency spectrums 20, 21 and of the alarm curve 1 are mapped against the vertical axis 10 of the diagram and the frequency is plotted against the horizontal axis 11 of the diagram. In the embodiment, the object to be tested takes the form of a machine. At least one acceleration sensor, e.g. in the form of a microphone, is attached to the machine. By means of this acceleration sensor, a typical frequency spectrum 20 of the machine is recorded, in this case at an actual rotational speed value of 100 revolutions per minute. The frequency spectrum 20 should be recorded with the machine in a fault-free normal state. In the event of the operating state of the machine not changing, changes in this frequency spectrum 20 point to changes in the machine itself. These changes may be caused e.g. by wear and tear or by defects in the machine. The changes in the frequency spectrum 20 are also perceptible in the audible range to a user. The machine begins, for example, to run noisily; it rattles or it squeaks. By means of the proposed vibro-acoustic method, the monitoring of frequency spectrums is automated and also extended to non-audible frequency ranges. To this end, a user projects an alarm curve 1 for the frequency spectrum 20 of the machine in the fault-free normal state. The alarm curve 1 forms an envelope curve of the frequency spectrum 20 such that the amplitude values of the frequency spectrum 20 do not during normal operation of the machine exceed the threshold values of the alarm curve 1 which are stipulated in each case. Even small deviations from the normal operating state of the machine can, however, be perceived in the pattern of the frequency spectrum 20. The operating state of the machine is characterized by a large number of operating parameters. Examples of such operating parameters are in a machine with rotating parts the rotational speed and in machines in general the loading or load of the machine, the temperature, the air humidity, the number of operating hours and similar environmental parameters. A deviation of the value of such an operating parameter from its value in the machine's normal state leads directly to a change in the amplitude values of the frequency spectrum 20 at defined frequencies. Changes in the operating parameters ‘actual rotational speed value’ and ‘loading of the machine’ can be seen particularly clearly. If the actual rotational speed value of the machine changes, then the frequency spectrum will be distorted in proportion to these rotational speed value changes along the horizontal frequency axis. FIG. 1 shows as an example the frequency spectrum 21 of the machine at an actual rotational speed value of eighty revolutions per minute. The second frequency spectrum 21 seems to be compressed in contrast to the first frequency spectrum 20. Since the alarm curve 1 in FIG. 1 was, however, defined for the first frequency spectrum 20 and thus forms an envelope curve in relation to the frequency spectrum 20, the second frequency spectrum 21 clearly exceeds the alarm curve 1. In the example, a fall in the actual rotational speed value would therefore trigger an alarm. In machines with changing rotational speed, this behavior is not usually desirable. Likewise, a change in the loading of the machine leads to a change in the associated frequency spectrum. Depending on the change in the loading, certain frequency components of the frequency spectrum will rise or fall and thus an alarm will be triggered unintentionally or an alarm will possibly be prevented.

Frequency spectrums 22, 23 and an alarm curve 2 are shown in FIG. 2. The amplitude values of the frequency spectrums 22, 23 and of the alarm curve 2 are plotted against the vertical axis 10. The frequency which has been normalized to the rotational speed, i.e. the quotient of frequency and actual rotational speed value, is plotted against the horizontal axis 12. As a result of the fact that the frequency spectrums 22, 23 are normalized to the rotational speed, the frequency spectrum 23 of a machine with a reduced rotational speed remains completely below the alarm curve 2. In contrast to the frequency spectrum 22, which was in turn recorded at an actual rotational speed value of one hundred revolutions per minute, the frequency spectrum 23, which was recorded at an actual rotational speed value of eighty revolutions per minute, changes only marginally in its amplitude values. The increases in the amplitude values of the frequency spectrum which are characteristic for the machine at certain resonance frequencies of the machine do not change their distribution along the horizontal axis 12, since the frequency was normalized to the rotational speed. The alarm curve 2, which is fixed for a defined operating state with a defined rotational speed, can thus be retained independently of the actual rotational speed value of the machine.

The frequency spectrums 22, 23 are not, however, dependent only on the operating parameter ‘rotational speed’, but also on a number of other operating parameters of the machine. Normalization of the frequency spectrums to different operating parameters can be achieved by multiplying the amplitude values of the alarm curve 2 by correction factors. These correction factors are in a functional relationship to the individual operating parameters. The curve of such a correction factor for correcting the amplitude values of the alarm curve 2 is shown in FIG. 3. The value of the correction factor is plotted against the vertical axis 15, and the value of the loading as an operating parameter is plotted against the horizontal axis 13. The functional relation between correction factor and loading is shown as curve 17. The trend in the curve 17 is projected before implementation of the method by a user and/or automatically adjusted during implementation of the method. The functional relation between an operating parameter and the correction factor for the amplitude values of an alarm curve is freely selectable here. If multiple operating parameters influence the appearance of the frequency spectrums, it is possible to determine multiple correction factors and to multiply the amplitude values of the alarm curve by the product of the correction factors. Since the alarm curve itself in turn represents a function of the frequency normalized to the rotational speed, the further possibility exists of applying in each case different functional relations between the operating parameters and the correction factors for the individual normalized frequency ranges.

FIG. 4 to FIG. 6 show frequency spectrums 24, 25, 26 and alarm curves 3, 4, 5 at different loadings of the machine in the embodiment. The amplitude values of the frequency spectrums and of the alarm curves are each plotted against the vertical axis 16. The frequency normalized to the rotational speed is plotted against the horizontal axis 14. The quantitative scales which are used for the vertical axes 16 and for the horizontal axes 14, are the same in each of FIGS. 4 to 6. The frequency spectrum 24 in FIG. 4 is recorded in a machine at no-load, the frequency spectrum 25 in FIG. 5 in the same machine at 50% loading and finally the frequency spectrum 26 in FIG. 6 in the same machine at a loading of 75%. The rotational speed of the machine is the same in each case. The increasing amplitude values of the frequency spectrums 24, 25 and 26 with increasing loading of the machine are clearly visible. In order for an alarm not to be triggered incorrectly by these rising amplitude values, the alarm curves 3, 4, 5 are increased appropriately by means of the method proposed. The correction factor by which the amplitude values of the alarm curve are multiplied is determined for example via the function shown as curve 17 in FIG. 3.

In a further embodiment, the alarm curve is automatically adjusted using the operating parameters ‘rotational speed’ and ‘load of an object to be tested’. The spectral key values of the alarm curve are normalized using the actual rotational speed value. If the spectral components are now also normalized in their frequency to the actual rotational speed value, the alarm curve and spectrum of the object to be tested can be compared with one another independently of the rotational speed. Since the vibration amplitudes change with the rotational speed and load, it is possible to change the values (threshold values) of the alarm curve according to the two parameters. The function ‘change of load/rotational speed to change of threshold value’ can be freely adjusted. For example, at one and a half times the load, the threshold values should be increased by a factor of two and at twice the load the threshold values should be increased by a factor of three. As a result, it is now possible to carry out a correct evaluation of the vibration signal and thus of the object to be tested, independently of the rotational speed and of the loading. Further operating parameters such as, for example, temperature and air humidity, can also be used for correcting the alarm curve. If n parameters influence the threshold values, then an n-dimensional correction function can also be applied.

In conclusion, the invention thus relates to a method for the spectral evaluation of an object to be tested, said method enabling an evaluation to be carried out independently of the respective operating state of the object to be tested, said operating state being characterized by operating parameters, a first operating parameter being an actual rotational speed value, whereby automatically a frequency spectrum 22, 23 of the object to be tested is recorded by measuring means, said frequency spectrum 22, 23 having first amplitude values which depend on first frequency values, the first frequency values of the frequency spectrum 22, 23 are used for normalization in relation to the actual rotational speed value, an alarm curve 2 is formed with second amplitude values which depend on second frequency values, the second frequency values of the alarm curve 2 are used for normalization in relation to the actual rotational speed value, the second amplitude values of the alarm curve 2 are changed according to the operating parameters, the first amplitude values of the normalized frequency spectrum 22, 23 are compared with the second amplitude values of the normalized alarm curve 2 which is changed according to the operating parameters and a result of the comparison is used to evaluate the object to be tested.

1. A method for the spectral evaluation of an object to be tested in operating states characterized by operating parameters, a first operating parameter being an actual rotational speed value, wherein automatically
a frequency spectrum (22, 23) of the object to be tested is recorded by measuring means, wherein the frequency spectrum (22, 23) has first amplitude values which depend on first frequency values,
the first frequency values of the frequency spectrum (22, 23) are used for normalization in relation to the actual rotational speed value,
an alarm curve (2) is formed with second amplitude values which depend on second frequency values,
the second frequency values of the alarm curve (2) are used for normalization in relation to the actual rotational speed value,
the second amplitude values of the alarm curve (2) are changed according to the operating parameters,
the first amplitude values of the normalized frequency spectrum (22, 23) are compared with the second amplitude values of the normalized alarm curve (2) which is changed according to the operating parameters, and a result of the comparison is used to evaluate the object to be tested.

2. A method according to claim 1, characterized in that the operating states of the object to be tested are characterized by a second operating parameter which is proportional to a load of the object to be tested.

3. A method according to claim 1 or claim 2, characterized in that the operating states of the object to be tested are characterized by a third operating parameter which is proportional to a temperature of the object to be tested.

4. A method according to one of the preceding claims, characterized in that the second amplitude values of the alarm curve (2) are changed according to a function of the operating parameters, which function can be specified by a user.

5. A method according to one of the preceding claims, characterized in that the alarm curve (2) which is normalized and changed according to the operating parameters forms an envelope curve over the normalized frequency spectrum (22, 23) of the object to be tested in a fault-free normal condition, wherein an alarm is generated if at least one amplitude value of the normalized frequency spectrum (22, 23) lies outside the envelope curve.

6. A method according to one of the preceding claims, characterized in that the measuring means are fashioned as vibro-acoustic measuring means.

7. Use of the method according to one of claims 1 to 6 for the spectral evaluation of a machine.

8. Use of the method according to one of claim 1 to 6 for monitoring the vibration of vehicle components.
